(19) United States
(12) Patent Application Publication
(10) Pub. No.: US 2025/0060587 A1
(43) Pub. Date: Feb. 20, 2025

(54) HEAD-UP DISPLAY

(71) Applicant: VALEO COMFORT AND DRIVING ASSISTANCE, Créteil (FR)

(72) Inventors: Pierre Mermillod, Créteil (FR); Stéphane Gache, Créteil (FR)

(73) Assignee: VALEO COMFORT AND DRIVING ASSISTANCE, Créteil (FR)

(21) Appl. No.: 18/720,440

(22) PCT Filed: Dec. 15, 2022
(86) PCT No.: PCT/EP2022/086088

§ 371 Date: Jun. 17, 2024

(30) Foreign Application Priority Data
Dec. 16, 2021 (FR) FR2113726

(51) Int. Cl. G02B 27/01

(52) U.S. Cl. CPC G02B 27/0103; G02B 2027/0105; G02B 2027/011; G02B 2027/0114

(57) ABSTRACT

A head-up display includes an image-generating system, and a projecting optical system that includes a common mirror and a folding mirror. The image-generating system is configured to emit a first source light beam and a second source light beam that pass through an image plane. The projecting system also includes an element for redirecting beams by diffraction that deflects the first source light beam downstream of the image plane into a first intermediate beam directed toward the common mirror. The folding mirror is configured to reflect the second source light beam downstream of the image plane into a second intermediate beam directed toward the common mirror. The common mirror is configured to intercept and project the first intermediate beam and the second intermediate beam to form a first virtual image at a first projection distance and a second virtual image at a second projection distance.

The present invention relates in general to the field of displays.

It more particularly relates to a head-up display, for example for a motor vehicle.

For the driver of a motor vehicle, it is particularly helpful to be able to view information relating to the operation of the vehicle, relating to a traffic lane ahead of the vehicle and so on without having to avert their gaze from this traffic lane in order to do so.

For this purpose, it is known practice to equip the motor vehicle with a display referred to as a “head-up” display comprising, inside a housing, an image-generating system from which a source light beam emerges and a projecting optical system designed to project an image generated by the image-generating device to the user, via the windshield for example, so as to form a virtual image in the field of view of a driver of said motor vehicle.

The virtual image, comprising the information to be displayed, is then superposed visually on the environment ahead of the vehicle.

Head-up displays that make it possible to project two virtual images onto the driver's windshield are also known. In this particular case, the two virtual images may be formed at different projection distances from, generally, one or more image-generating systems emitting multiple source beams combined with various projecting optical systems. Each projecting optical system projects one of the source beams, generally via a mirror, so as to form one of the virtual images.

However, there are head-up displays that project a double virtual image using a single image-generating system and a mirror common to the various projecting optical systems. This type of architecture is economically advantageous because of the small number of components, but also technically because it allows the field of optical performance of the head-up display to be extended.

In fact, designing a head-up display projecting a double virtual image using a single image-generating system and a mirror common to the various projecting optical systems is not easy because of constraints imposed by the specifications to be met by the head-up display, such as projection distances, the size of the single image-generating system, positioning constraints on the center of the virtual images with respect to the direction of the observer's gaze, or even the shape of the common mirror.

In order to remedy this problem, the present invention provides a head-up display comprising:
an image-generating system;
a projecting optical system comprising a common mirror and a folding mirror; characterized in that:
the image-generating system is configured to emit a first source light beam and a second source light beam that pass through an image plane;
the projecting system further comprises an element for redirecting beams by diffraction that is configured to deflect the first source light beam, downstream of the image plane into a first intermediate beam directed toward the common mirror;
the folding mirror is configured to reflect the second source light beam downstream of the image plane into a second intermediate beam, directed toward the common mirror;
said common mirror is configured to intercept and project said first intermediate beam and said second intermediate beam, to form a first virtual image at a first projection distance and a second virtual image at a second projection distance, respectively.

The present invention has the advantage of employing a diffractive optical element, this making it possible to adjust the deflection angle of the first source beam free of the constraints of the laws of specular reflection. Thus, the invention allows flexibility in the architecture of the head-up display, in particular by reducing the number of components to be integrated and provides a solution that is inexpensive and easy to integrate.

For example, the first source light beam passes through the image plane in a first zone defining a first intermediate image and the second source light beam passes through the image plane in a second zone defining a second intermediate image.

For example, the element for redirecting beams by diffraction is positioned between the common mirror and the folding mirror.

For example, the first projection distance is less than the second projection distance.

In one embodiment, the element for redirecting beams by diffraction is embodied by a holographic plate.

In particular, the element for redirecting beams by diffraction may be a volume holographic optical element.

In one embodiment, the element for redirecting beams by diffraction is embodied by a stack of holographic plates.

In another embodiment, the element for redirecting beams by diffraction is a diffractive optical element.

For example, the first source light beam is incident on the element for redirecting beams by diffraction in a first region and the second source light beam is incident on the element for redirecting beams by diffraction in a second region separate from the first region.

For example, the first source light beam and the second source light beam overlap in a first zone of the image plane.

In another example, the first source light beam and the second source light beam overlap in a first zone of the element for redirecting beams by diffraction.

For example, the first source beam comprises a first segment the emission spectrum of which has a first spectral component centered on a first wavelength and the element for redirecting beams by diffraction is configured to deflect only said first segment. Thus, the first source beam is altered only by the element for redirecting beams by diffraction. If the emission spectrum consists solely of the first spectral component, the first virtual image will be perceived to be monochrome.

The first source beam may comprise at least one other segment different from the first segment, the at least one other segment having an emission spectrum comprising additional spectral components centered on additional wavelengths different from the first wavelength, and the element for redirecting beams by diffraction may further be configured to deflect the at least one other segment. In this case, the first virtual image can for example be perceived in colors.

The second source beam may have an emission spectrum comprising at least one secondary spectral component, said at least one secondary spectral component being centered on a secondary wavelength different from the first wavelength and, where appropriate, from the additional wavelengths.

This configuration makes it possible to differentiate the channel of projection of the first virtual image from that of the second virtual image, thereby making the element for redirecting beams by diffraction insensitive to the second source beam.

For example, the image-generating system comprises at least one laser source for emitting at least partly the first source light beam. In this configuration, the first source beam is spectrally coherent and may effectively interact with the element for redirecting beams by diffraction.

Also for example, the image-generating system comprises at least one light-emitting diode for emitting at least partly the second source light beam. Indeed, unlike the first source light beam, there is no constraint regarding the spectral coherence of the second source light beam, which interacts with the folding mirror.

Of course, the various features, variants and embodiments of the invention may be associated with one another in various combinations provided that they are not mutually exclusive or incompatible.

In addition, various other features of the invention will become apparent from the appended description, which is provided with reference to the drawings, which illustrate non-limiting embodiments of the invention and in which:

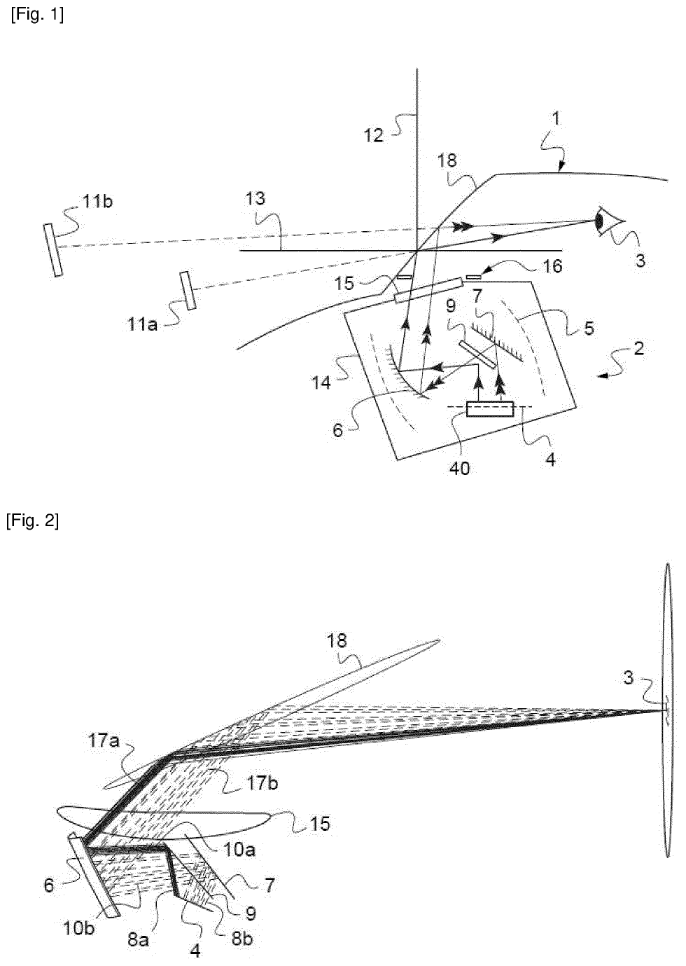

FIG. 1 is a schematic view showing the integration of a head-up display according to the invention into a motor vehicle.

FIG. 2 is an enlarged view of one embodiment of the head-up display of FIG. 1 showing the path of light rays output by the image-generating system through the head-up display to the driver's eye.

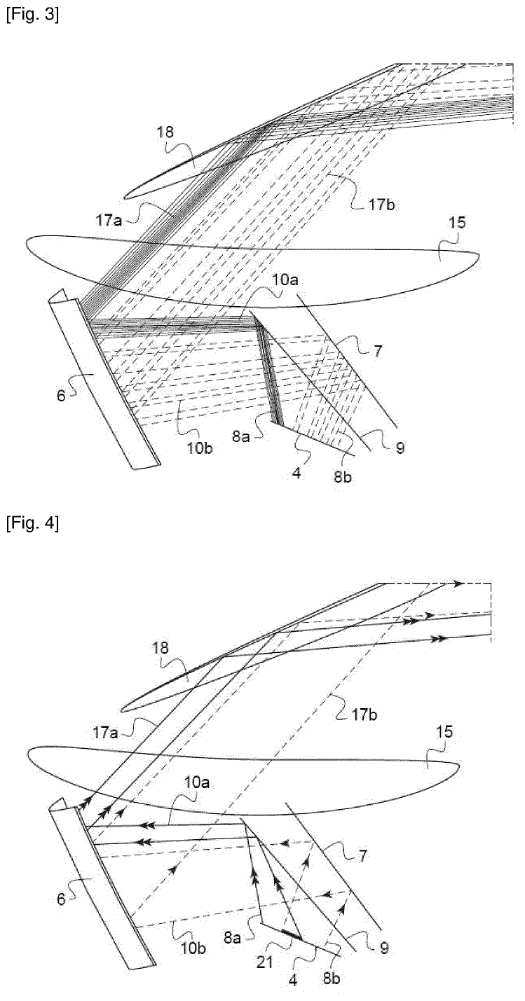

FIG. 3 is a detailed view of the embodiment of FIG. 2.

FIG. 4 is another detailed view similar to FIG. 2 in the case of another embodiment.

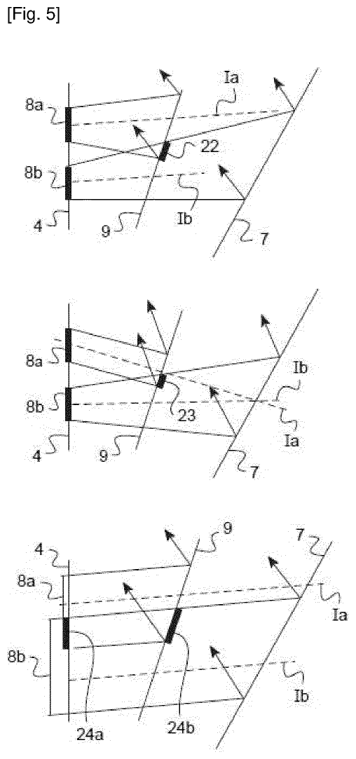

FIG. 5 shows various possible geometries of a first source light beam and of a second source light beam used in the context of the invention.

It will be noted that in these figures structural and/or functional elements common to the various variants may have the same reference signs.

FIG. 1 schematically depicts, from the side, a motor vehicle 1, equipped with a head-up display 2 according to the invention. An individual, here the driver 3 (of whom only an eye is depicted), is located in the passenger compartment of the vehicle.

The head-up display 2 first of all comprises a housing 14 which is generally placed under a dashboard 16 of the vehicle 1 and has, here in its upper part close to the dashboard 16, an opening closed by a transparent window 15 which is configured to let pass the various light beams useful to the operation of the display, as explained below.

As shown in FIG. 1, the head-up display 2 comprises, inside this housing 14, an image-generating system 40 that generates a first image and a second image that is spatially distinct from the first image, and a projecting optical system 5 comprising a common mirror 6 and a folding mirror 7.

The image-generating system 40 may for example comprise a laser screen comprising one or more laser sources forming an array of dots on a diffuser. What is meant by diffuser is an optical element intended to uniformly distribute the light emanating from a light source. The image-generating system 40 may, as a variant, comprise a Digital Light Processing (DLP) projector also associated with a diffuser. As another example, the image-generating system 40 may comprise a Liquid Crystal on Silicon (LCoS) screen. In this case, one particular configuration is a holographic system, where the LCoS screen is used as a spatial light modulator, and where the beam originating from the LCoS screen undergoes a Fourier transform before reaching a diffuser.

In all cases, according to the invention, in order to generate the first image, the image-generating system 40 comprises one or more spectrally coherent, i.e. monochromatic, sources.

The image-generating system 40 emits a first source light beam 8a and a second source light beam 8b.

In the case where the image-generating system 40 comprises a laser screen, the latter may comprise one or more laser sources for generating the first source beam 8a, and one or more laser sources for generating the second source light beam 8b.

In the case where the image-generating system 40 comprises a DLP projector, the latter may comprise one or more laser sources for generating the first source beam 8a, and one or more laser sources or one or more light-emitting diodes for generating the second source light beam 8b.

In the case where the image-generating system 40 comprises a LCoS screen, the latter may comprise one or more laser sources for generating the first source beam 8a, and one or more laser sources for generating the second source light beam 8b.

The images generated by the image-generating system 40 are generated in accordance with a control signal originating from the on-board computer (not shown) of the vehicle 1.

The first source beam 8a and the second source beam 8b pass through an image plane 4 and thereby generate therein a first intermediate image in a first zone and a second intermediate image in a second zone, respectively. When the image-generating system 40 comprises a diffuser, the latter is positioned in the image plane 4.

As illustrated in FIG. 2, the projecting system 5 further comprises an element 9 for redirecting beams by diffraction. The element 9 for redirecting beams by diffraction deflects, in a first projection channel, the first source light beam 8a into a first intermediate beam 10a directed toward the common mirror 6.

The folding mirror 7 for its part reflects, in a second projection channel, the second source light beam 8b into a second intermediate beam 10b directed toward the common mirror 6.

Next, the common mirror 6 intercepts the first intermediate beam 10a and the second intermediate beam 10b, respectively, and projects them outwards through the transparent window 15 of the housing 14 so as to form a first virtual image 11a at a first projection distance and a second virtual image 11b at a second projection distance, respectively.

For example, the first projection distance is less than the second projection distance.

The element 9 for redirecting beams by diffraction is here located between the common mirror 6 and the folding mirror 7. Moreover, in the described example, the image plane 4 is closer to the element 9 for redirecting beams by diffraction than to the folding mirror 7. Thus, a first optical path formed by the sum of the distance between the image plane 4 and the element 9 for redirecting beams by diffraction, and the distance between the element 9 for redirecting beams by diffraction and the common mirror 6, is shorter than a second optical path formed by the sum of the distance between the image plane 4 and the folding mirror 7, and the distance between the folding mirror 7 and the common mirror 6. The first optical path corresponds to the path traveled by the light to form the first virtual image 11a, while the second optical path corresponds to the path traveled by the light to form the second virtual image 11b. In this configuration, the second virtual image 11b is called the augmented-reality image, and the first virtual image 11a is called the standard image. The augmented-reality image is generally viewed at a far-off distance, whereas the standard image is viewed at a distance closer to the driver 3.

For example, the first virtual image 11a is situated below the second virtual image 11b in the vertical direction 12. Specifically, if the first virtual image 11a is the standard image, and if the second virtual image 11b is the augmented-reality image, the first virtual image 11a is seen by the driver lower down, i.e. with a greater look-down angle, than the second virtual image 11b.

The vertical direction 12 may be defined as being perpendicular to the horizontal direction 13. The horizontal direction 13 may for its part be defined as being the direction substantially parallel to the road over which the vehicle 1 is being driven. In other words, the horizontal direction 13 could be said to be the direction of the instantaneous speed of the vehicle 1 moving over the road.

In the two preceding cases, typically, the second virtual image 11b is an augmented-reality image that is superposed on a specific object located in the real scene, for example using detectors or via analysis of the real scene, the image for example being determined depending on this object. For example, the second virtual image 11b may be used to warn the driver 3 of the presence of a pedestrian by representing a frame around her or him, or of the presence of automobiles by representing a frame around them, or to indicate the road to follow by representing highlighting thereof. The first virtual image 11a may then be used to display information that is uncorrelated with a particular object of the real scene, such as current speed, the level of the fuel gauge, outside temperature or even other dashboard information.

For example, the first virtual image 11a has dimensions smaller than those of the second virtual image 11b.

The light beam, obtained from the first intermediate beam 10a and projected by the common mirror 6 and that then passes through the transparent window 15, will be called the first final beam 17a. Likewise, the light beam, obtained from the second intermediate beam 10b and projected by the common mirror 6 and that then passes through the transparent window 15, will be called the second final beam 17b.

The first final beam 17a and the second final beam 17b are projected toward a partially transparent plate 18. The partially transparent plate 18 reflects the first final light beam 17a and the second final beam 17b in the direction of the driver 3. The latter then sees the virtual image projected by the first source light beam 8a, which corresponds to the first virtual image 11a, and the virtual image projected by the second source light beam 8b, which corresponds to the second virtual image 11b, said virtual images being formed by reflection from the partially transparent plate 18.

The path of the component light rays of the first source beam 8a, of the second source beam 8b, of the first intermediate light beam 10a, of the second intermediate light beam 10b, of the first final beam 17a and of the second final beam 17b is illustrated in FIG. 2.

Here, the partially transparent plate 18 is the windshield of the vehicle 1. As a variant, however, the partially transparent plate 18 could be a dedicated combiner, for example one located between the windshield of the vehicle and the transparent window 15 of the housing of the head-up display 2.

Advantageously, the common mirror 6 is curved, and for example optimized so as to respectively increase the magnification of the first projection channel and the magnification of the second projection channel 5b and/or to compensate for optical distortions or aberrations that could be caused by the reflection from the windshield 18. For example, the common mirror may be an aspherical mirror, or a mirror of polynomial shape.

In one embodiment, the element 9 for redirecting beams by diffraction is embodied by a holographic plate. In particular, the element for redirecting beams by diffraction may be a volume holographic optical element (VHOE) recorded in the holographic plate and operating in reflection. What is meant by volume holographic optical element operating in reflection is a volume Bragg grating manufactured by recording interference fringes in the holographic plate. The volume Bragg grating reflects monochromatic light, of wavelength equal to the recording wavelength, also called the first wavelength, incident on the grating with a given angle of incidence, into light at the first wavelength in a given diffraction direction. The given diffraction direction depends on the geometric characteristics of the volume holographic optical element, which themselves depend on the recording parameters of the volume holographic optical element.

In a first variant, the holographic plate has a size such that it intercepts the second source beam 8b. The volume holographic optical element may either be recorded in the entirety of the holographic plate, or in the portion of the holographic plate that intercepts only the first source beam 8a.

In a second variant, the holographic plate has a size adjusted to the volume occupied by the first source beam 8a. In other words, the holographic plate does not intercept the second source beam 8b.

Thus, by choosing the parameters with which the volume holographic optical element is recorded in the holographic plate, it is possible to configure the diffraction direction in which the latter reflects monochromatic light and therefore to configure the deflection angle of the first source beam 8a. This increases the design flexibility of the head-up display 2 according to the invention because it allows flexibility in how its components are positioned and orientated, as a result of the configurability of the deflection angle of the first source beam 8a. This property is made possible through use of the element 9 for redirecting beams by diffraction and is much harder to envision if, as in the prior art, purely specular components, which impose more constraints on the reflection angles, are used.

In this embodiment, the first source beam 8a has an emission spectrum comprising a spectral component centered on the first wavelength and the second source beam 8b does not emit light at the first wavelength. Specifically, to dissociate the first source beam 8a and the virtual image 11a projected by the latter from the second source beam 8b and the virtual image 11b projected by the latter, respectively, the second source beam 8b must not be affected by the volume holographic optical element and must be able to pass through the latter to reach, where appropriate, the folding mirror 7 and the common mirror 6. For example, the spectral component centered on the first wavelength has a width at half-height of 2 nm.

Generally, according to the invention, the emission spectrum of the first source beam 8a and the emission spectrum of the second source beam 8b are separate. The element 9 for redirecting beams by diffraction is transparent to the spectrum of the second source beam 8b so that the latter may pass through it, where appropriate, without being altered. For example, if the second source beam 8b has an emission spectrum separate by at least 5 nanometers from the effective spectrum of the element 9 for redirecting beams by diffraction, the second source beam 8b will not interact with the element 9 for redirecting beams by diffraction. What is meant by effective spectrum is the light spectrum to which the element 9 for redirecting by diffraction is sensitive.

For example, in order to obtain a colored first virtual image 11a and a colored second virtual image 11b, the first source beam 8a may have an emission spectrum with three spectral components centered on 470 nm (blue), 527 nm (green) and 630 nm (red), respectively, while the second source beam 8b may have an emission spectrum with three spectral components centered on 475 nm (blue), 532 nm (green) and 650 nm (red), respectively. White balance may be adjusted by adjusting the level of each of the spectral components.

FIG. 3 is a detailed view of the path of the light rays in the first projection channel and the second projection channel. It may be seen that the first source beam 8a is deflected by the element 9 for redirecting beams by diffraction toward the common mirror 6. It may also be seen that the second source beam 8b passes through the element 9 for redirecting beams by diffraction, strikes the folding mirror 7, is specularly reflected by the latter toward the common mirror, and then passes back through the element 9 for redirecting beams by diffraction without being altered thereby.

In this embodiment, the first source beam 8a may have an emission spectrum comprising only the spectral component around the first wavelength. Consequently, the first virtual image is perceived as being monochrome by the conductor 3.

The first source beam 8a and the second source beam 8b may have zones of overlap. The zones of overlap are determined by the position of the first virtual image 11a and of the second virtual image 11b, and also by the eye box, i.e. the set of places where the eyes of the driver may be found in a driving situation. FIG. 4 illustrates an example where the first source beam 8a and the second source beam 8b overlap spatially in the image plane 4, in a zone 21. As explained below, the first source beam 8a and the second source beam 8b may also overlap at the element 9 for redirecting beams by diffraction.

In a second embodiment, the element 9 for redirecting beams by diffraction is embodied by a stack of holographic plates. In particular, the element for redirecting beams by diffraction may be a stack of volume holographic optical elements recorded in each holographic plate and all operating in reflection.

For example, the element 9 for redirecting beams by diffraction consists of a stack of a first volume holographic optical element operating at a first wavelength centered in the red spectrum, of a second volume holographic optical element operating at an additional second wavelength centered in the green spectrum, and of a third volume holographic optical element operating at an additional third wavelength centered in the blue spectrum.

In this example, the first source beam 8a has an emission spectrum comprising a first spectral component centered on the first wavelength, a second spectral component centered on the additional second wavelength and a third spectral component centered on the additional third wavelength. The image-generating system 40 may typically have a first segment generating the first image, consisting of a laser screen comprising three red, green and blue laser sources. Thus, the first virtual image 11a may be perceived in color by the driver. The image-generating system 40 may then have a second segment generating the second image and having an emission spectrum comprising at least one secondary spectral component centered on a secondary wavelength different from the first wavelength, from the additional second wavelength and from the additional third wavelength. For example, the second segment may be illuminated by one or more laser sources emitting in a spectrum different from the red, green and blue spectra, or by one or more light-emitting diodes emitting in a spectrum different from the red, green and blue spectra.

In a third embodiment, the element 9 for redirecting beams by diffraction is a diffractive optical element (DOE). What is meant by diffractive optical element is an optical element operating via diffractive effects.

For example, the diffractive optical element may be an etched diffraction grating operating in reflection and designed to reflect only in a single diffraction order. Given that a diffraction grating may reflect any wavelength, in order to avoid there being a plurality of angles of deflection of the first source beam as a result of the spectrum of the first source beam 8a having a number of different spectral components, the first source beam 8a preferably has, in this example, a monochromatic emission spectrum. This monochromatic emission spectrum is centered on a principal wavelength chosen depending on the deflection angle of the first source beam 8a, which is configured to the architecture of the head-up display 2. As in the other embodiments, the emission spectrum of the second source beam 8b, or in other words of the one or more sources illuminating the segment of the image-generating system 40 generating the second image, will be chosen not to contain the main wavelength of the monochromatic spectrum of the first source beam 8a.

Also for example, the diffractive optical element may be a binary optical element, i.e. one having a surface structure that is quantized heightwise.

In a first variant, the diffractive optical element may be etched on a carrier of a size such that this carrier intercepts the second source beam 8b. The diffractive optical element may be etched in the entirety of the carrier, or only in the portion of the carrier intercepting the first source beam 8a.

In a second variant, the size of the carrier is tailored to the volume occupied by the first source beam 8a. In other words, the carrier does not intercept the second source beam 8b.

FIGS. 2, 3 and 4 illustrate embodiments with a holographic plate in which a volume holographic optical element is recorded, or a stack of holographic plates in each of which a volume holographic optical element is recorded, or a diffractive optical element. In the case of the embodiment with a diffractive optical element, it is preferable for the first source light beam 8a and the second source light beam 8b not to overlap at the element 9 for redirecting beams by diffraction. Specifically, the diffractive optical element reacts not to a single wavelength but to all wavelengths and could therefore interact with both the first source light beam 8a and the second source light beam 8b if they were to overlap at the diffractive optical element. This could generate parasitic images. In other words, the first source light beam 8a is incident on the element 9 for redirecting beams by diffraction in a first region and the second source light beam 8b is incident on the element 9 for redirecting beams by diffraction in a second region separate from the first region.

One of the advantages of using either a holographic plate comprising a volume holographic optical element, or a stack of holographic plates comprising a plurality of volume holographic optical elements, as element 9 for redirecting beams by diffraction is that it allows, by wavelength filtering, interaction of the element 9 for redirecting beams by diffraction with the second source beam 8b to be prevented in the case where the first source light beam 8a and the second source light beam 8b overlap at the element 9 for redirecting beams by diffraction. Any parasitic image resulting from such an interaction is therefore avoided.

Using either a holographic plate comprising a volume holographic optical element, or a stack of holographic plates comprising a plurality of volume holographic optical elements, as element 9 for redirecting beams by diffraction therefore allows greater flexibility in the design and architecture of the various components of the head-up display 2 according to the invention, for example flexibility in the overlap of the first source light beam 8a and second source light beam 8b.

FIG. 5 illustrates a plurality of configurations of overlap of the first source light beam 8a with the second source light beam 8b, in which the overlap is located at the element 9 for redirecting beams by diffraction. These configurations are therefore possible in the case where the element 9 for redirecting beams by diffraction is a holographic plate or a stack of holographic plates.

In a first configuration corresponding to the top schematic of FIG. 5, the first source light beam 8a and the second source light beam 8b have parallel indicators Ia and Ib. What is meant by indicator is the mean direction of propagation. The first source light beam 8a and the second source light beam 8b overlap at the element 9 for redirecting beams by diffraction, in a zone 22.

In a second configuration corresponding to the middle schematic of FIG. 5, the first source light beam 8a and the second source light beam 8b have non-parallel indicators Ia and Ib. The first source light beam 8a and the second source light beam 8b overlap at the element 9 for redirecting beams by diffraction, in a zone 23.

In a third configuration corresponding to the schematic at the bottom of FIG. 5, the first source light beam 8a and the second source light beam 8b have parallel indicators Ia and Ib and overlap both in the image plane 4, in a zone 24a, and at the element 9 for redirecting beams by diffraction, in a zone 24b.

Using the element 9 for redirecting beams by diffraction according to the invention makes it possible to dissociate the first projection channel, which corresponds to the projection channel of the first virtual image 11a, and the second projection channel, which corresponds to the projection channel of the second virtual image 11b. This results in a simplified architecture of the head-up display 2 according to the invention, with a single image-generating system 40 and a mirror 6 common to the first projection channel and to the second projection channel. This small number of components makes it possible to reduce the manufacturing cost of the head-up display but also to envision decreasing the bulk of the head-up display 2.

1. A head-up display comprising:
an image-generating system;
a projecting optical system comprising a common mirror and a folding mirror;
wherein the image-generating system is configured to emit a first source light beam and a second source light beam that pass through an image plane;
wherein the projecting system further comprises an element for redirecting beams by diffraction that is configured to deflect the first source light beam downstream of the image plane into a first intermediate beam directed toward the common mirror;
wherein the folding mirror is configured to reflect the second source light beam downstream of the image plane into a second intermediate beam directed toward the common mirror;
wherein the common mirror is configured to intercept and project the first intermediate beam and the second intermediate beam, to form a first virtual image at a first projection distance and a second virtual image at a second projection distance, respectively.

2. The head-up display as claimed in claim 1,
wherein the element for redirecting beams by diffraction is positioned between the common mirror and the folding mirror.

3. The head-up display as claimed in claim 1,
wherein the first projection distance is less than the second projection distance.

4. The head-up display as claimed in claim 1,
wherein the element for redirecting beams by diffraction is embodied by a holographic plate.

5. The head-up display as claimed in claim 4,
wherein the element for redirecting beams by diffraction is a volume holographic optical element.

6. The head-up display as claimed in claim 1,
wherein the element for redirecting beams by diffraction is embodied by a stack of holographic plates.

7. The head-up display as claimed in claim 1,
wherein the element for redirecting beams by diffraction is a diffractive optical element.

8. The head-up display as claimed in claim 1,
wherein the first source light beam is incident on the element for redirecting beams by diffraction in a first region and the second source light beam is incident on the element for redirecting beams by diffraction in a second region separate from the first region.

9. The head-up display as claimed in claim 1,
wherein the first source light beam and the second source light beam overlap in a first zone of the image plane.

10. The head-up display as claimed in claim 1,
wherein the first source light beam and the second source light beam overlap in a first zone of the element for redirecting beams by diffraction.

11. The head-up display as claimed in claim 1,
wherein the first source beam comprises a first segment the emission spectrum of which has a first spectral component centered on a first wavelength and the element for redirecting beams by diffraction is able to deflect only the first segment.

12. The head-up display as claimed in claim 11,
wherein the first source beam comprises at least one other segment different from the first segment,
wherein the at least one other segment has an emission spectrum comprising additional spectral components centered on additional wavelengths different from the first wavelength, and
wherein the element for redirecting beams by diffraction is further able to deflect the at least one other segment.

13. The head-up display as claimed in claim 11,
wherein the second source beam has an emission spectrum comprising at least one secondary spectral component,
wherein the at least one secondary spectral component is centered on a secondary wavelength different from the first wavelength and, where appropriate, from the additional wavelengths.

14. The head-up display as claimed in claim 1,
wherein the image-generating system comprises at least one laser source for emitting at least partly the first source light beam.

15. The head-up display as claimed in claim 1,
wherein the image-generating system comprises at least one light-emitting diode for emitting at least partly the second source light beam.
